(19) United States
(12) Patent Application Publication
(10) Pub. No.: US 2008/0055395 A1
(43) Pub. Date: Mar. 6, 2008

(54) CREATING A DYNAMIC GROUP CALL THROUGH SIMILARITY BETWEEN IMAGES

(75) Inventors: Von A. Mock, Boynton Beach, FL (US); Yong C. Lee, Chandler, AZ (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/467,942

(22) Filed: Aug. 29, 2006

(51) Int. Cl. H04N 7/14

(52) U.S. Cl. 348/14.01

(57) ABSTRACT

A method (300, 400) for identifying an entity of interest to a user of a communication device (110). The method can include receiving an image (115) from the communication device and processing the image to identify at least one feature of the image. The method also can include, based on the identified feature, selecting at least one business entity that is associated with the identified feature and that is located in a geographic region in which the communication device is located. In another arrangement, at least one user or user group associated with the identified feature can be selected based on the identified feature. A communication group can be created that includes the selected user. The communication group can be a call group. In another arrangement, a text chat session that includes the selected user can be created.

### BACKGROUND OF THE INVENTION

1. Field of the Invention

The present invention generally relates to communications systems and, more particularly, to communications systems that support transfer of image data.

2. Background of the Invention

The use of mobile stations has grown to an extent that such devices are now ubiquitous throughout most of the industrialized world. Just as their use has grown, so too has the functionality of mobile stations. Indeed, mobile stations now can be used not only for voice communications, but also to perform a number of other tasks. For example, mobile stations can be used to take photographs, capture and stream video, browse the Internet, play games, and send and receive instant messages and e-mail. Nonetheless, consumers continue to demand ever greater functionality, flexibility and ease of use from their mobile stations.

### SUMMARY OF THE INVENTION

The present invention relates to a method for identifying an entity of interest to a user of a communication device. The method can include receiving an image, for example a photograph, from the communication device and processing the image to identify at least one feature of the image. The method also can include, based on the identified feature, selecting at least one business entity that is associated with the identified feature and that is located in a geographic region in which the communication device is located. The process of selecting the business entity can include selecting at least one attribute that is associated with the identified feature and selecting at least one business entity to which the attribute has been associated. An identifier associated with the selected business entity can be communicated to the communication device.

The business entity can be selected from a list of advertisers. In an arrangement in which a plurality of business entities is selected, identifiers that are associated with the plurality of the selected business entities can be communicated to the communication device. In one aspect of the invention, the identifiers can be presented in an order based on rankings of the business entities. The rankings can be based on advertising fees received from the business entities. In another aspect of the invention, the rankings can be based on the distance of the business entities from the communication device.

The present invention also relates to a method for identifying an entity of interest to a user of a communication device. The method can include receiving an image from the communication device and processing the image to identify at least one feature of the image. At least one user, or user group, associated with the identified feature can be selected based on the identified feature. Further, a communication group can be created that includes the selected user. The communication group can be a call group, for example a push-to-talk over cellular dynamic call group. In another arrangement, a text chat session that includes the selected user can be created. In yet another arrangement, a user selection can be received to broadcast a push-to-talk over cellular message to the selected user. Further, a user selection can be received to identify the selected user to include in the communication group.

The present invention also relates to a server that includes a network adapter and a processor. The network adapter can receive an image, such as a photograph, from the communication device and the processor can process the image to identify at least one feature of the image. Based on the identified feature, the processor can select at least one business entity that is associated with the identified feature and that is located in a geographic region in which the communication device is located. The business entity can be selected from a list of advertisers. The network adapter then can communicate an identifier associated with the selected business entity to the communication device.

The network adapter can communicate to the communication device identifiers associated with a plurality of the selected business entities, the identifiers being presented in an order based on rankings of the business entities. The business entities can be ranked based on advertising fees received from the business entities and/or based on their distance from the communication device.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a block diagram of a server that is useful for understanding the present invention;

FIG. 3 is a flowchart that is useful for understanding the present invention; and

FIG. 4 is another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system that, from an image, identifies an entity of interest to a user of a communication device. In particular, a server can receive an image from the communication device and process the image to identify one or more features in the image. Based on the identified features, one or more entities associated with the identified features can be selected and information about such entities can be forwarded to the communication device. For example, if the received image is a photograph that depicts a motorcycle, the server can identify the motorcycle in the image and select one or more users who have expressed interest in motorcycles. The server also can select one or more motorcycle user groups. In another aspect of the inventive arrangements, the server can identify one or more business entities that relate to motorcycles and that are located in a geographic region in which the user is located. The server then can forward information related to the selected users, groups and/or business entities to the communication device. Such information can include addresses, telephone numbers, contact names, e-mail addresses, hyperlinks and/or any other information that may be relevant to the user.

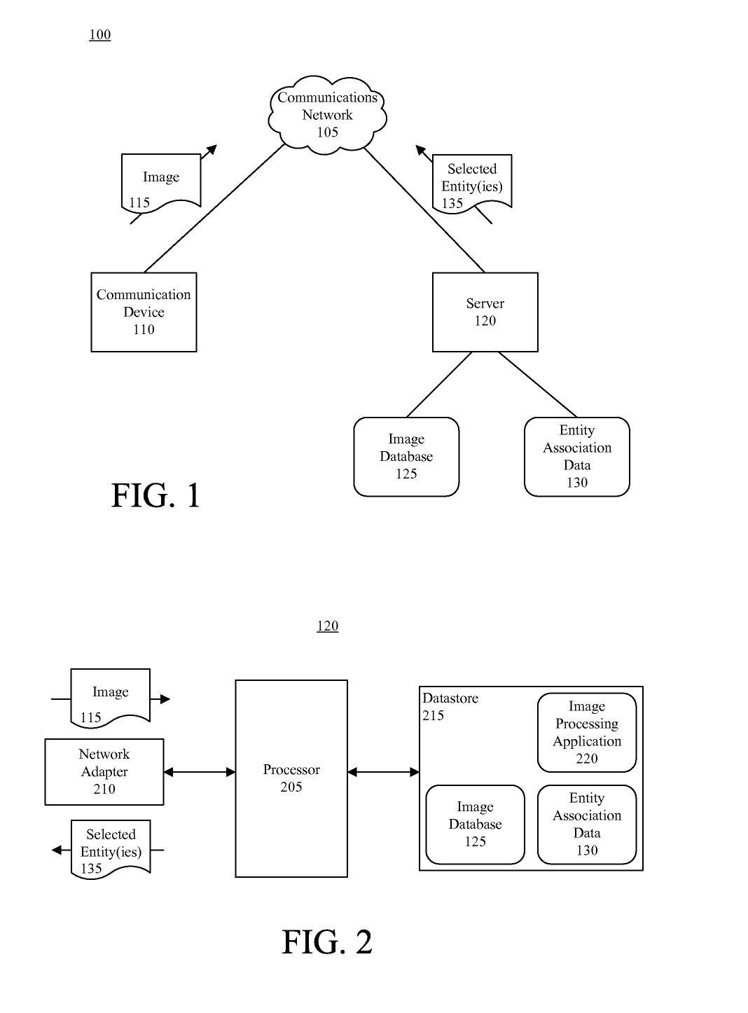

FIG. 1 depicts a communications system 100 that is useful for understanding the present invention. The communications system 100 can include a communications network 105, which can comprise, for example, the Internet, the World Wide Web, a wide area network (WAN), a local area network (LAN), a cellular communications network, a dispatch communications network, an interconnect communications network, a public switched telephone network (PSTN), and/or any other networks or systems over which communication signals can be propagated. In that regard, the communications network can include wired and/or wireless communication links.

The communications system 100 can include a communication device 110. The communication device 110 can be a mobile station, such as a mobile computer, a personal digital assistant (PDA) or a mobile telephone, a computer, a game console, a set top box, or any other electronic apparatus that may be used to communicate an image 115. As such, the communication device 110 can include a suitable wired or wireless network adapter to send and receive the image 115 via the communications network 105. Further, the communication device 110 can execute one or more applications for capturing images and performing other functions of the communication device 110 described herein.

The image 115 can comprise a photograph, drawing, sketch, and/or any other pictorial representation. Via the communications network 105, the communication device 110 can communicate the image 115 to a server 120 configured to receive and process the image 115. The communication device 110 can be triggered to communicate the image 115 in any suitable manner. For example, in an arrangement in which the communication device 110 utilizes dispatch communication features, a push-to-talk button can be depressed to initiate communication of the image 115. Alternatively, the image 115 can be automatically communicated to the server 120 in response to the image 115 being acquired, for example in response to a photograph being taken. Whether to automatically communicate the image 115 in this manner can be determined by a user selectable setting within the communication device 110.

The server 120 can receive the image 115 from the communication device 110 and process the image 115 to identify one or more features contained in the image 115 using known image recognition techniques. For example, a discriminator algorithm can process the image 115 to identify objects in the image 115, and decomposition can be performed on such objects to identify different quantifiable salient parameters. The image decomposition can include radiometric correction, segmentation and/or segment group generation. For each generated segment group, additional processing steps can be performed, for instance bounding box generation, geometric normalization, wavelet decomposition, color cube decomposition, shape decomposition and/or low-resolution grayscale image generation. Such techniques are described in U.S. Patent Application Publication No. US 2002/0090132 A1 filed Nov. 5, 2001, which is herein incorporated by reference in its entirety. In the case of conflict, the present specification, including definitions, will control.

After a feature contained in the image 115 has been identified, the server 120 can access an image database 125 which associates each of a plurality of image features with unique attributes. The attributes can be, for instance, alphanumeric terms that correlate to the image features. For example, the image database 125 can contain records or files that associate an image of a motorcycle with the term “motorcycle” and associate an image of an air conditioning unit with the term “air conditioner.” Similarly, the image database 125 can contain records or files that associate particular brands of products with terms corresponding to those brands. In such an arrangement, the identified features of the image 115 can include features unique to the particular product brands. Such features can include, for instance, logos, patterns, geometry, etc., but the invention is not limited in this regard. From the image database 125, the server 120 can select at least one attribute that is associated to the identified feature(s) of the image 115.

The server 120 then can access entity association data 130 to select at least one entity that has been associated with the selected attribute. Expanding on the above example, if a motorcycle has been identified in the image 115, the server 120 can select users, user groups or business entities to which the term “motorcycle” has been associated. In one arrangement, the users, user groups or business entities can be selected based on location. For example, the users, user groups or business entities that are selected can be such entities that are located within, or serve, a geographic region in which the communication device 110 is located. The geographic region can be a village, a city, a county, a state, a country, or any other region that may be geographically defined.

The location of the communication device 110 can be determined using any of a myriad of techniques known to the skilled artisan. For example, the location of the communication device 110 can be determined by identifying a network node (e.g. access point, base transceiver station, repeater, etc.) on which the communication device 110 has established a communication session, or using a positioning system, such as a local positioning system or a global positioning satellite system.

After selecting entities that correlate to the identified features of the image 115, the server 120 can communicate a message 135 to the communication device 110 that includes information associated with one or more of the selected entities. The information can be presented to a user of the communication device 110 as hyperlinks to web pages, telephone numbers, fax numbers, e-mail addresses, addresses, contacts, or presented in any other suitable fashion.

In one arrangement, the listing of the business entities or user groups presented by the message 135 can be limited to those entities that pay an advertising fee (i.e. the entities can be selected from a list of advertisers). Moreover, the entities can be presented in an order based on entity rankings. The entities can be ranked based on, for example, their distance from the communication device 110 and/or the amount of advertising fees paid. Still, the entity rankings can be determined in any other suitable manner and the invention is not limited in this regard.

In another arrangement, the listing can include users who also have communicated to the server 120 (or other suitable servers) images that are similar to the image 115, or users who have otherwise indicated an interest in the feature(s) identified in the image 115. In response to receiving and processing the image 115, the server 120 can automatically create a communication group that includes such other users as well as the user of the communication device 110. For example, a push-to-talk over cellular (PoC) dynamic call group can be created. In one arrangement, the user of the communication device 110 may be presented an option to select other users and/or groups separately to create the dynamic call group or to perform a broadcast PoC message to selected entities. Such user selections can be entered into the communication device and communicated to the server 120. In yet another arrangement, a text chat session can be established among the automatically created group or among the selected entities.

FIG. 2 depicts a block diagram of the server 120 that is useful for understanding the present invention. The server 120 can be a base transceiver station (BTS), a base station controller (BSC), a mobile switching center (MSC), a web server, a network server, or any other network device suitable for implementing the server functions described herein. The server 120 can include a processor 205. The processor 205 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The server 120 also can include a network adapter 210 to receive the image 115 from the communication device and communicate the list of selected entities 135 to the communication device. The network adapter 210 can be any network adapter suitable for communicating via the communications network. For example, the network adapter can include a transceiver that communicates data via wireless communications and/or wired communications.

Further, the server 120 can include a datastore 215. The datastore 215 can include one or more storage devices, each of which can include a magnetic storage medium, an electronic storage medium, an optical storage medium, a magneto-optical storage medium, and/or any other storage medium suitable for storing digital information. In one arrangement, the datastore 215 can be integrated into the processor 205. An image processing application 220 can be contained on the datastore 215. The image processing application 220 can be executed by the processor 205 to implement the methods and processes described herein which are allocated to the server 120. The image database 125 and entity association data 130 also can be stored on the datastore 215, or stored elsewhere in the communications system.

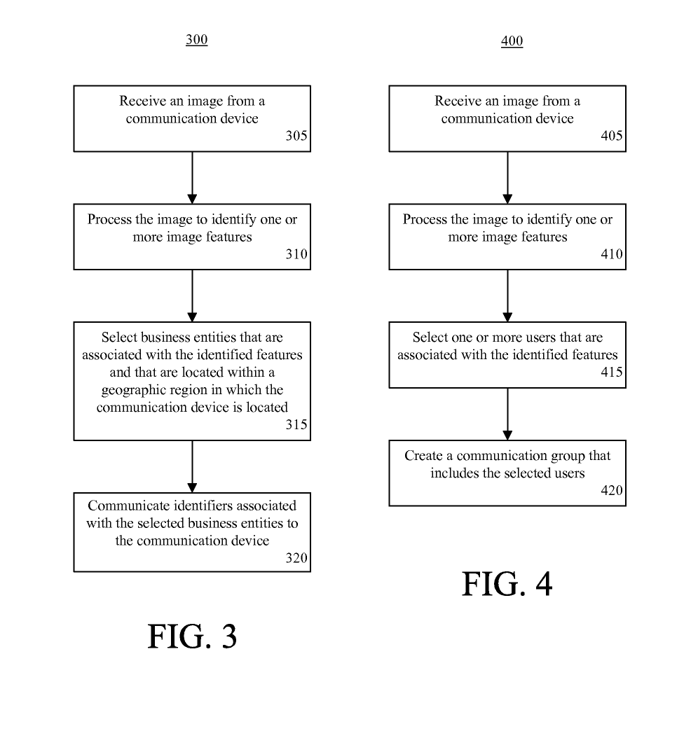

FIG. 3 is a flowchart presenting a method 300 that is useful for understanding the present invention. Beginning at step 305, the server can receive an image from the communication device. At step 310, the server can process the image to identify one or more image features. Proceeding to step 315, the server can select business entities that are associated with the identified features and that are located within a geographic region in which the communication device is located. At step 320, the server can communicate identifiers associated with the selected business entities to the communication device.

FIG. 4 is another flowchart presenting a method 400 that is useful for understanding the present invention. Beginning at step 405, the server can receive an image from the communication device. At step 410, the server can process the image to identify one or more image features. Proceeding to step 415, the server can select one or more users that are associated with the identified features. Continuing to step 420, a communication group that includes the selected users can be created. The communication group can be, for instance, PoC dynamic call group or a text chat session group.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for identifying an entity of interest to a user of a communication device, comprising:
receiving an image from the communication device;
processing the image to identify at least one feature of the image; and
based on the identified feature, selecting at least one business entity that is associated with the identified feature and that is located in a geographic region in which the communication device is located; and
communicating an identifier associated with the selected business entity to the communication device.

2. The method of claim 1, wherein receiving the image comprises receiving a photograph.

3. The method of claim 1, wherein selecting the business entity comprises selecting the business entity from a list of advertisers.

4. The method of claim 1, further comprising communicating to the communication device identifiers associated with a plurality of the selected business entities, the identifiers being presented in an order based on rankings of the business entities.

5. The method of claim 4, further comprising ranking the business entities based on advertising fees received from the business entities.

6. The method of claim 4, further comprising ranking the business entities based on their distance from the communication device.

7. The method of claim 1, wherein selecting the business entity comprises:
selecting at least one attribute that is associated with the identified feature; and
selecting at least one business entity to which the attribute has been associated.

8. A method for identifying an entity of interest to a user of a communication device, comprising:
receiving an image from the communication device;
processing the image to identify at least one feature of the image; and
based on the identified feature, selecting at least one user associated with the identified feature; and
creating a communication group that includes the selected user.

9. The method of claim 8, wherein selecting the user comprises selecting a user group.

10. The method of claim 8, wherein creating the communication group comprises creating a call group.

11. The method of claim 8, wherein creating a communication group comprises creating a push-to-talk over cellular dynamic call group.

12. The method of claim 8, wherein creating the communication group comprises establishing a text chat session that includes the selected user.

13. The method of claim 8, wherein creating the communication group comprises receiving a user selection to broadcast a push-to-talk over cellular message to the selected user.

14. The method of claim 8, wherein creating the communication group comprises receiving a user selection identifying the selected user to include in the communication group.

15. A server, comprising:
a network adapter that receives an image from the communication device; and
a processor that processes the image to identify at least one feature of the image and, based on the identified feature, selects at least one business entity that is associated with the identified feature and that is located in a geographic region in which the communication device is located;
wherein the network adapter further communicates an identifier associated with the selected business entity to the communication device.

16. The server of claim 15, wherein the image comprises a photograph.

17. The server of claim 15, wherein the business entity is selected from a list of advertisers.

18. The server of claim 15, wherein the network adapter communicates to the communication device identifiers associated with a plurality of the selected business entities, the identifiers being presented in an order based on rankings of the business entities.

19. The server of claim 15, wherein the business entities are ranked based on advertising fees received from the business entities.

20. The server of claim 15, wherein the business entities are ranked based on their distance from the communication device.
